(19) United States
(12) Patent Application Publication
(10) Pub. No.: US 2011/0231127 A1
(43) Pub. Date: Sep. 22, 2011

(54) Apparatus for High Precision Measurement of Varied Surface and Material Levels

(75) Inventors: Jules J. DiRienzo, Chalfont, PA (US); Kevin G. Hafer, Douglassville, PA (US); John E. Naghski, Wyndmoor, PA (US); Travis D. Hopkins, Willow Grove, PA (US)

(73) Assignee: AMETEK, INC., Berwyn, PA (US)

(21) Appl. No.: 13/131,684

(22) PCT Filed: Nov. 30, 2009
(86) PCT No.: PCT/US09/66090

§ 371 Date: May 27, 2011

Related U.S. Application Data
(60) Provisional application No. 61/118,548, filed on Nov. 28, 2008.

(51) Int. Cl. G06F 19/00; G01F 23/26

(52) U.S. Cl. 702/65; 73/304 C

(57) ABSTRACT

An apparatus and method for measuring the level of a wide range of varied surfaces or materials housed within vessels, and for detecting contact with a solid surface within the vessel is disclosed. A high precision radio frequency admittance measuring system, using capacitance to measure levels of process materials, coupled with detection element to sense contact of the detection element with a solid surface, such as a floating roof. An active element and ground element in coaxial relationship provides means for measuring the level of process materials including water, oil, kerosene, jet fuel, gasoline. Along with detecting the level of a solid surface within the vessel such as a floating roof. One preferred application of the inventive apparatus is to provide vessel or tank overfill protection. The apparatus detection element is capable of sensing level and non-level solid surfaces.

### RELATED APPLICATION

This application claims the benefit of priority to U.S. Provisional Patent Application Ser. No. 61/118,548, filed on Nov. 28, 2008, the text and figures of which are incorporated into this application by reference.

### FIELD OF THE INVENTION

The present invention generally relates to the measurement of the height of the surface level of varied materials housed within vessels or tanks. More particularly, the disclosed invention relates to an apparatus and system that comprises a radio frequency (“RF”) admittance measuring device using capacitance to precisely measure the level of a process material, coupled with a detection element to detect a threshold level of a solid surface within the vessel or tank, and calibration software, all of which, in combination permit accurate measurement of the level of a wide range of process materials stored within the vessel or tank.

The software determines, among other system aspects, initial capacitance set points for the measuring device. In a preferred embodiment the apparatus and system is capable of measuring, with a high degree of precision, the level of various process materials housed within a vessel or tank including, without limitation, water, oil, kerosene, jet fuel, gasoline, and other liquids, as well as detecting the level of a solid surface within the vessel or tank, such as a floating roof.

### BACKGROUND OF THE INVENTION

In many industrial plants, vessels or tanks store a wide range of process materials. Examples of such process materials housed within vessels or tanks include water, oil, kerosene, jet fuel, gasoline, diesel fuel, and many other liquid and non-liquid chemicals and products. The overall physical design of such storage vessels include, as illustrated in FIGS. 1A, 1B and 1C, structures with a fixed roof (FIG. 1A), an internal floating or moveable roof with a fixed exterior roof (FIG. 1B), and an external floating or moveable roof (FIG. 1C).

Most industrial applications of storing materials in vessels require that there is a means to ensure the vessel is not overfilled with the material being stored within the vessel. The primary reasons for not overfilling a vessel are safety concerns, environmental issues, structural limits, and because certain materials can be expensive, financial considerations. More particularly, if the vessel is overfilled, the result could include loss of the excess material being transferred to the vessel, damage to the vessel due to structural loads, and/or contamination of the area around the vessel due to the potential spillage of the excess material. Moreover, if the material being stored within the vessel is corrosive or volatile, such as gasoline, jet fuel, or kerosene, the potential for spillage could result in the need for expensive clean up and remediation around the vessel site should there be any spillage. In addition, as a vessel ages, the structural limits of the vessel may degrade, so the level limits for such older vessels are derated or lowered. Accordingly, overfill protection is a critical need in many, if not most vessel storage applications.

Various examples of measurement devices and systems have been disclosed and used within material storage vessels. However, each of these known devices and systems have deficiencies which prevent such devices and systems from fully addressing the level measurement problems. By way of example, U.S. Pat. No. 4,811,160, for a Capacitance-Type Material Level Probe issued to Fleckenstein and assigned to Berwind Corporation discloses a capacitance probe for material level sensing, and a method of manufacturing the probe. There is however no disclosure of use of the capacitance probe for high precision measurement of material level within a vessel where the probe is also able to detect contact with a floating solid surface within the vessel.

Similarly, U.S. Pat. No. 5,554,937 teaches an Apparatus And Method For Sensing Material Level By Capacitance Measurement, and issued to Sanders et al., and is assigned to Penberthy, Inc. The '937 patent specifically discloses a system to measure the level of material in a vessel where the probe is maintained in the vessel such that the vessel and probe are at different potentials thereby creating a capacitance between the probe and vessel wall. As described within the '937 patent, as the material level varies, the capacitance will similarly vary. The '937 patent however provides no disclosure of any means to detect a solid surface within the vessel while also measuring the material level within the vessel.

Accordingly, there does not appear to be any known prior art devices, systems, methods, patents, or published patent applications that disclose or address the potential advantages of having a highly precise capacitance level probe for use within a material vessel to measure material level within the vessel, that is also coupled with a detection element to detect contact with a floating roof or other solid surface. The inventive apparatus, systems and methods described below disclose solutions to the above noted problems relating to the measurement and monitoring of material with vessels. Such an apparatus, system and method of operation would be highly desirable to system operators that use and monitor vessels with process materials stored in the vessels. Such improved apparatus, systems and methods have not been seen or achieved in the relevant art.

### SUMMARY OF THE INVENTION

The above noted problems, which are inadequately or incompletely resolved by the prior art are completely addressed and resolved by the present invention.

A preferred aspect of the present invention is an apparatus for measuring the level of a material within a vessel and for detecting the level of a solid surface within said vessel, comprising a capacitance probe for measuring the level of the material within the vessel to a high degree of precision, said capacitance probe having an active element and a ground element in close lateral proximity to each other, said capacitance probe further having a proximate end and a distal end; and a detection element incorporated into the distal end of the capacitance probe for detecting the level of a solid surface within the vessel.

Another preferred aspect of the present invention is a system for measuring the surface level of a material stored within a vessel, comprising a capacitance probe for measuring the level a material within the vessel, said capacitance probe having a proximate end and a distal end; a detection element coupled with the distal end of the capacitance probe for detecting the level of a solid surface within the vessel; and a computer processor to calibrate and monitor the capacitance probe.

A further preferred embodiment of the present invention is an apparatus for measuring the level of a material within a vessel and for detecting the level of a solid surface within said vessel, comprising a capacitance probe for measuring the level of the material within the vessel, said capacitance probe having an active element and a ground element, wherein the active element and ground element are in a co-axial relationship with each other; and said active element detects the level of a solid surface within the vessel.

Another further preferred aspect of the present invention is a system for measuring the surface level of a material stored within a vessel, comprising a capacitance probe for measuring the level of the material within the vessel, said capacitance probe having an active element and a ground element, wherein the active element and ground element are in a co-axial relationship with each other; and said active element detects the level of a solid surface within the vessel; and a computer processor to calibrate and monitor the capacitance probe.

Still another preferred embodiment of the present invention is a method for measuring the level of a material or distinct solid surface within a vessel using a capacitance probe coupled with a detection element, and a computer processor, comprising the steps of (a) calibrating the level of the capacitance probe through the computer processor, (b) monitoring the level of the material within the vessel, and monitoring any contacts of solid surfaces with the detection element, through the computer processor; and (c) providing output data of the material level as measured by the capacitance probe or if a solid surface contacts the detection element.

In still another preferred embodiment of the present invention is a method for measuring the level of a material or distinct solid surface within a vessel using a capacitance probe coupled with a detection element, and a computer processor, comprising the steps of (a) calibrating the level of the capacitance probe through the computer processor; (b) monitoring the level of the material within the vessel through the computer processor; (c) providing output data of the material level as measured by the capacitance probe; (d) monitoring any contacts of solid surfaces with the detection element through the computer processor; and (e) providing output data if a solid surface contacts the detection element.

The invention will be best understood by reading the following detailed description of the several disclosed embodiments in conjunction with the attached drawings that are briefly described below.

### BRIEF DESCRIPTION OF THE DRAWINGS

The invention is best understood from the following detailed description when read in connection with the accompanying drawings. It is emphasized that, according to common practice, the various features of the several drawings are not to scale, and the invention is not limited to the precise arrangement as may be shown in the accompanying drawings. On the contrary, the dimensions and locations of the various features are arbitrarily expanded or reduced for clarity, unless specifically noted in the attached claims.

FIG. 1A: is an open side view illustration of a fixed roof vessel with an embodiment of the present invention within the vessel;

FIG. 1B: is an open side view illustration of a fixed roof vessel and floating solid surface with an embodiment of the present invention within the vessel;

FIG. 1C: is an open side view illustration of an open roof vessel having a floating solid surface with an embodiment of the present invention within the vessel;

FIG. 2: is an illustration of an embodiment of the present invention capacitance probe and detection element within a vessel connected to a computer processor;

FIG. 3A: is an end and side view of an illustration of an embodiment of the present invention capacitance probe with a solid disk detection element design;

FIG. 3B: is an end and side view of an illustration of an embodiment of the present invention capacitance probe with a spoke and rim detection element design;

FIG. 3C: is an end and side view of an illustration of an embodiment of the present invention capacitance probe showing an internal active element and exterior ground element;

FIG. 3D: is an end and side view of an illustration of an embodiment of the present invention capacitance probe showing an internal ground element and exterior active element;

FIG. 4: is an illustration of an embodiment of the present invention capacitance probe and detection element within a vessel communicating wirelessly to a computer processor;

FIG. 5A: is an illustration of an embodiment of the present invention capacitance probe and detection element within a vessel, with a cable coiling device connected to the capacitance probe;

FIG. 5B: is an illustration of an embodiment of the present invention capacitance probe and detection element within a vessel, with a cable coiling device connected to the capacitance probe and communicating wirelessly with the system processor;

FIG. 6: is an illustration of an embodiment of the present invention capacitance probe and detection element within a vessel, with a cover over the capacitance probe;

FIG. 7: is an illustration of an embodiment of the present invention capacitance probe and detection element within a vessel, with a heating element coupled with the capacitance probe;

FIG. 8: is an open side view illustration of an embodiment of the present invention within a fixed roof vessel having a floating solid surface within the vessel, showing contact of the detection element with a floating solid surface;

FIG. 9A: is an example flowchart of the steps of a preferred embodiment of the present invention method of measuring the level of a material within a vessel and of detecting a solid surface within the vessel; and

FIG. 9B: is another example flowchart of the steps of a preferred embodiment of the present invention method of measuring the level of a material within a vessel separate from the detecting a solid surface within the vessel.

### DETAILED DESCRIPTION OF PREFERRED EMBODIMENTS

The present invention is an apparatus, system and method for measuring the height of the surface level of a material stored in vessel with a high degree of precision, and for detecting the threshold level of a solid surface which may also be within the vessel. A detailed description of various preferred embodiments of the inventive apparatus, systems and methods is provided in this specification.

The core elements of the inventive apparatus include a capacitance probe for precisely measuring the level of a material stored within the vessel, and a detection element conductively coupled to the capacitance probe to detect a solid surface within the vessel. The design of the capacitance probe having an active element in close proximity with a ground element, including by way of example, co-axially positioned with respect to each other, permits the probe to precisely measure, within a very limited probe measurement range, the level or height of a large group of process materials stored within a vessel. The inventive system further provides for a computer processor communicating with the capacitance probe and detecting element to calibrate the capacitance probe, including its position or level, as well as to monitor signal data from the probe and the detection element. The inventive method includes, in one basic preferred embodiment, the steps of (a) calibrating the level of the capacitance probe, (b) monitoring the level of the material within the vessel through the computer processor and/or monitoring any contacts of solid surfaces with the detection element, and (c) providing output data of the material level as measured by the probe, and/or contacts with a solid surface, to the system operator.

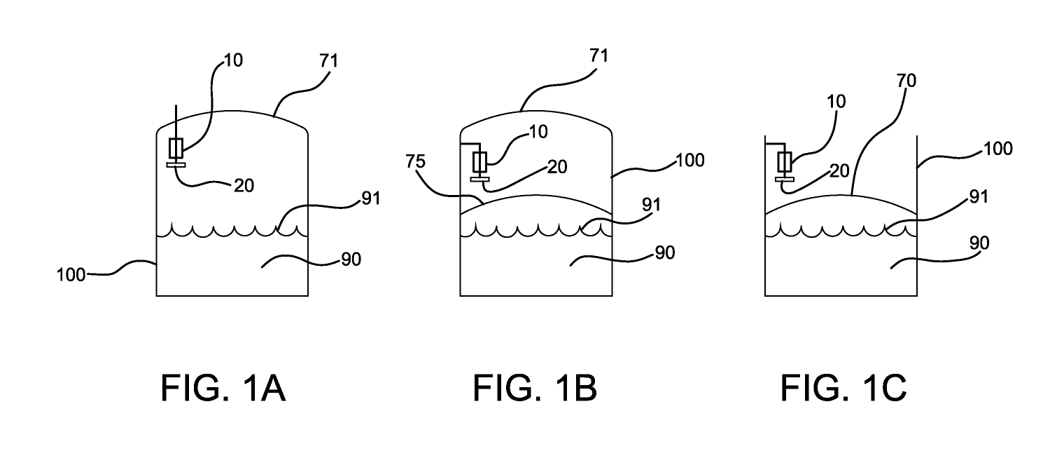

As shown in FIGS. 1A, 1B, and 1C, a storage vessel 100 may have an exterior, fixed roof 71 (FIG. 1A), an exterior, fixed roof 71 along with a moveable or floating roof 75 (FIG. 1B), or have no exterior roof, but only a moveable or floating roof 70 (FIG. 1C). Each of these example vessels have different issues to be addressed with respect to measuring the level of a process material 90 that may be stored within the vessel 100, and with respect to detecting the height of a moveable, interior roof. In order to be able to measure the level or height 91 of material stored within the vessel 100, along with being able to detect the height of a solid surface, such as a moveable roof 70, 75 within the vessel 100, a preferred embodiment of the inventive apparatus 10 combines a high precision surface measuring capacitance probe with a detecting element.

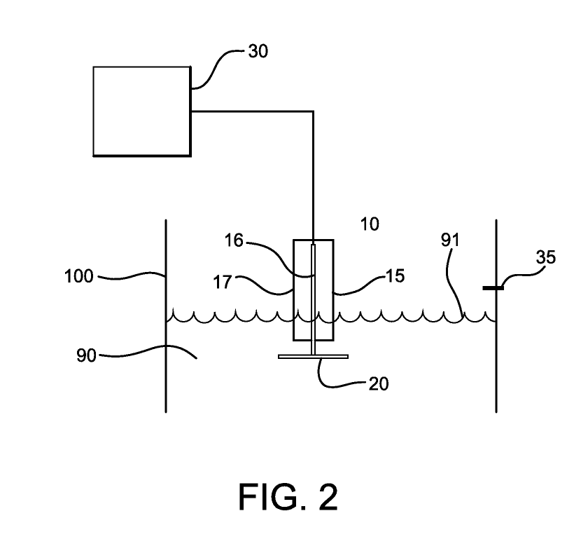

In a preferred embodiment, as illustrated in FIG. 2, the measuring device 10 has a concentric design capacitance probe 15, with a center active element 16 and an outer ground wall 17, coupled with a detecting element 20 connected to the distal end of the capacitance probe 15 active element 16. More specifically, in a preferred embodiment, the detecting element 20 is an extension of the center active element 16. The measuring device 10 is electrically connected to and communicating with a processor 30. Through such communications, the processor 30 is able to calibrate the probe 15 initial signals, including probe 15 level, and is thereafter able to detect material levels as measured by the capacitance probe 15. Moreover, the processor 30 monitors any signals generated from any contacts between the detecting element 20 and a solid surface within the vessel 100. The processor 30 may be, in different aspects of the inventive apparatus and system, a digital computer processor, or in a more simplified embodiment, an analog electrical circuit.

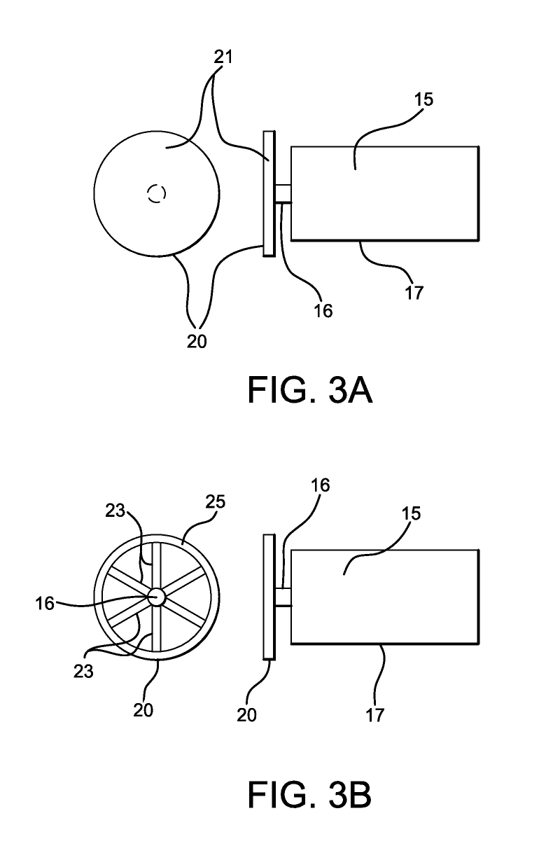

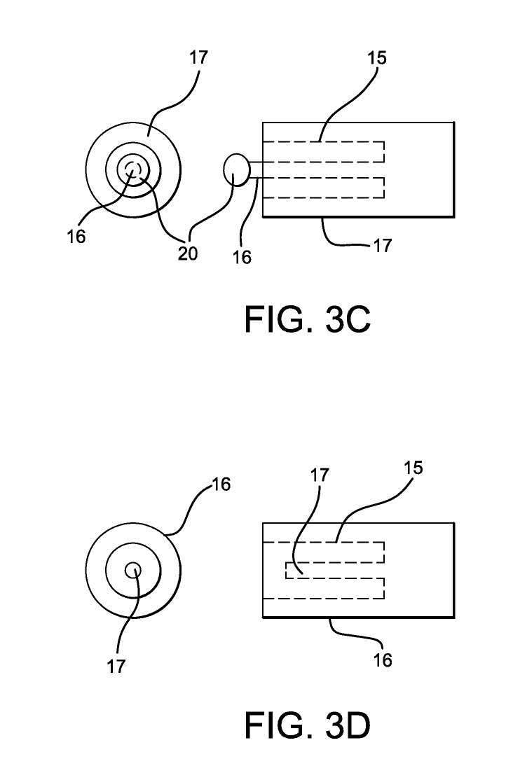

FIG. 3A illustrates an example embodiment of the measuring device where the detecting active element 20 is in the form of a circular disk 21 with a diameter such that the edge of the disk 21 is wider than the diameter of the ground wall 17 of the capacitance probe 15. In another preferred embodiment, as shown in FIG. 3B, the detecting element 20 is in the form of multiple spokes 23 connected at the center to measuring device center element 16, and at the edge, connected to a rim element 25.

FIG. 3C illustrates a similar embodiment of the measuring device as shown in FIG. 3A, except that the detecting active element 20 is not in the shape of a disk, and is not wider than the diameter of the ground wall 17. In this embodiment, the detecting active element 20 merely extends beyond the distal end of the capacitance probe ground wall 17.

FIG. 3D shows an alternative embodiment of the measuring device such that the active element and the ground element are reversed. More specifically, the ground element 17 is the interior element of the capacitance probe 15 and is coaxially surrounded by the active element 16. In this embodiment, the ground element 17 can be recessed within the exterior surrounding active element 16. Because the active element 16 surrounds the ground element 17 of the capacitance probe 15 and is the exterior of the capacitance probe, the active element 16 is able to detect contacts with any floating solid surfaces within a vessel.

The illustrative designs of the capacitance probe 15 shown in FIGS. 3A, 3B, 3C, and 3D, having the active element 16 in close lateral proximity with the ground element 17, provides the means through which the capacitance probe 15 is capable of measuring with a high degree of precision the level or height of a wide range of process materials stored within a vessel. The co-axial designs illustrated in FIGS. 3A through 3D allows the capacitance probe 15 to accurately measure the level of a wide range of dielectrics, including within the range of 2 to 80, within approximately 0.75 inch along the capacitance probe 15. With higher sensitive electronics and variations in the geometric distances between the active element 16 and ground element 17, further refinement of the precision of level measurements may be readily achieved.

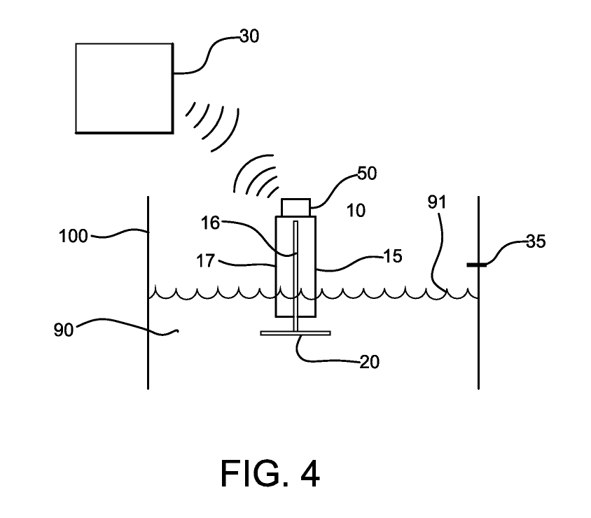

In another preferred embodiment of the measuring and detecting system, the measuring device 10 may communicate with the processor 30 wirelessly. Such wireless communications require that the measuring device have its own local power supply, which as shown in FIG. 4 can be a replaceable or rechargeable battery 50. One consideration with the wireless communication embodiment is the ability to effectively maintain a reliable communications link between the measuring device 10 and the processor 30. Moreover, having a local power supply 50 integrated with the measuring device 10 may require the use of special insulating materials around the power supply when the measuring device 10 is used with highly volatile stored materials. Accordingly, certain vessel and stored material environments may not be conducive to a wireless implementation.

FIG. 2 and FIG. 4 show the measuring device 10 within the vessel 100. As illustrated in both FIGS. 2 and 4, the level of the process material 90 is above the detecting element 20 and above the distal or bottom end of the capacitance probe 15. With respect to operation of the measuring and detecting system, as the process material 90 within the vessel 100 rises, the material 90 fills the area between the probe center active element 16 and the ground wall 17. As shown in FIGS. 3A, 3B and 3C, the area between the center element 16 and the probe ground wall 17 is open. As the process material 90 fills the vessel 100, and accordingly the material level 91 rises, the process material 90 fills the area between the center element 16 and probe ground wall 17. With the process material 90 filling part of the area between the center active element 16 and probe ground wall 17, the measured capacitance of the capacitance probe 15 changes. Similarly for the capacitance probe 15 embodiment shown in FIG. 3D, the process material 90 would fill the area between the ground element 17 and exterior active element 16 as the material level rises within the vessel, and the measured capacitance will proportionally vary. That is variations in the measured capacitance of the capacitance probe 15 directly correlate with variations in the level 91 of the process material 90. Because the computer processor 30 may initially calibrate the measuring device 10, any variations in the measured capacitance are used to provide variations in the level of the process material 90.

More particularly, the measuring device 10 measures the capacitance from the capacitance probe 15 and transmits a signal of that capacitance to the processor 30. The processor 30 then can compare the measured capacitance value to a set trip point 35 that is stored within the processor 30 memory. When the capacitance signal equals or exceeds the user selected trip point 35, the processor 30 may then transmit a signal to stop filling the vessel 100 with material 90, or alternatively transmit an alarm signal to a user that the trip point level 35 has been reached within the vessel 100.

While FIGS. 2 and 4 show expanded views of the measuring device 10 within a vessel 100, to specifically illustrate the filling of the process material 90 within the measuring device 10, the illustrations shown in FIGS. 1A, 1B and 1C exemplify particular configurations where the measuring device may be located near the top of the vessel 100. The placement of the measuring device 10 may also be located at any depth within the vessel 100. As such the user may position the measuring device at any desired level that is in appropriate relationship to the selected surface level 91 trip point 35.

As illustrated in FIGS. 1B and 1C, the vessel 100 may also include a moveable or floating solid surface positioned within the vessel 100. The floating surface or floating roof 75 may be located below a fixed roof 71 as shown in FIG. 1B, or alternatively, the floating roof 70 may be exposed to the open environment as shown in FIG. 1C. The floating roof 70, 75, is typically fully floating on top of the process material 90. Accordingly, as the process material 90 level rises, the floating roof 70, 75 will likely be the first material or surface to contact the measuring device 10. The inventive device and system illustrated in FIGS. 3A and 3B includes a detecting element 20 connected to the end of the capacitance probe 15 such that when a solid surface, such as a floating roof 70, 75 contacts the detecting element 20, a “contact” signal is transmitted to the processor 30 indicating contact of the solid surface 70, 75 with the detecting element 20. For the FIG. 3D embodiment, a floating roof 70, 75 would contact the exterior active element 16 and the “contact” signal would be transmitted to the processor 30.

As disclosed above, in a preferred embodiment, the detecting element 20 is an extension of the center active element 16 of the measuring device 10. Accordingly, if the floating solid surface 70, 75 within the vessel 100 contacts the detecting element 20, or the exterior active element 16, the solid surface 70, 75 acts as an electrical ground. The user may desire that if the floating roof 70, 75 contacts the measuring device 10, that such contact should provide a signal to the processor 30 and the user of such contact. More particularly, in a preferred embodiment of the inventive system, if the processor 30 receives such a “contact” signal from the detecting element 20, active element 16 or measuring device 10, the processor 30 may transmit a signal to stop filling the vessel 100, and/or transmit a “contact” alarm to the system operator.

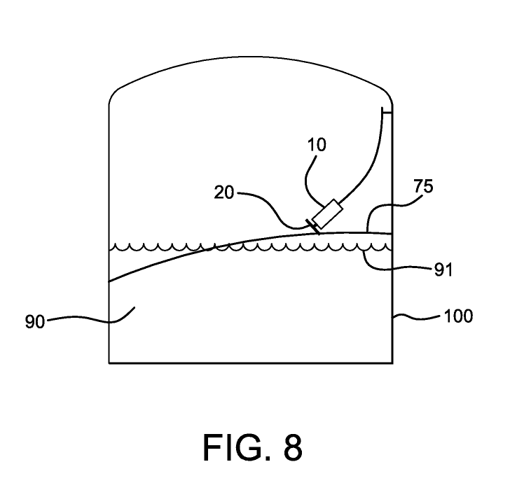

Because the roof 70, 75 is a floating surface, there may exist scenarios where the storage material 90 may have leaked partially or fully above the floating roof 70, 75. FIG. 8 illustrates an example of a partially submerged roof The design of the inventive measuring and detecting device 10 provides that a signal is sensed by the processor 30, and transmitted to the user or system operator whether the signal is a trip level signal, due to measuring a high level of the process material 90, or a contact signal, due to contact of a solid surface with the detecting element 20 or active element 16.

In a preferred embodiment of the inventive system, the measuring device 10 need not differentiate between a trip signal generated where the process material 90 (being a conductive process material) first contacts the capacitance probe 15 (e.g., where there is no floating roof 70, 75, or the floating roof 70, 75 has submerged below the process material 90), and alternatively where the floating roof 70, 75 first contacts the measuring device 10 and detecting element 20 or active element 16 (e.g., where there is an internal floating roof 75, or external floating roof 70 that is above the process material 90). The inventive system may, however, in another preferred embodiment, be configured such that the measuring device 10 and/or the processor 30 are able to distinguish between a trip signal generated where the process material 90 contacts the measuring device 10 and reaches the trip level 35, and where a floating roof, 70, 75 first contacts the measuring device 10 and detecting element 20 or active element 16.

The detecting element 20 may be designed to be a disk-shaped element as shown in FIGS. 2 and 3A, such that upon contact of a solid surface with the disk 20, a contact signal is transmitted to the processor 30. One preferred embodiment of the inventive apparatus, as shown in FIG. 2, has the detecting element disk 20 with a wider diameter than the capacitance probe 15. In this preferred embodiment, the detecting element 20 is fully operable whether the measuring device 10 is vertically oriented, as shown in FIG. 2, or if the device 10 is askew or oriented almost horizontally, as illustrated in FIG. 8, due to wind conditions. Similarly the capacitance probe embodiment shown in FIG. 3D would effectively operate to sense contacts with solid surfaces even with the measuring device 10 being askew because the active element 16 is the exterior of the capacitance probe 15.

As disclosed, in a preferred embodiment of the inventive system, the selected trip level 35 for the process material 90 may be set by the user. Accordingly, the trip level may vary depending upon different factors including consideration of the process material 90, environmental conditions (e.g., temperature, pressure, weather conditions), fill rate, and/or age of the vessel 100. As such, it may be advantageous to be able to locate the measuring device 10 at varied heights with the vessel 100.

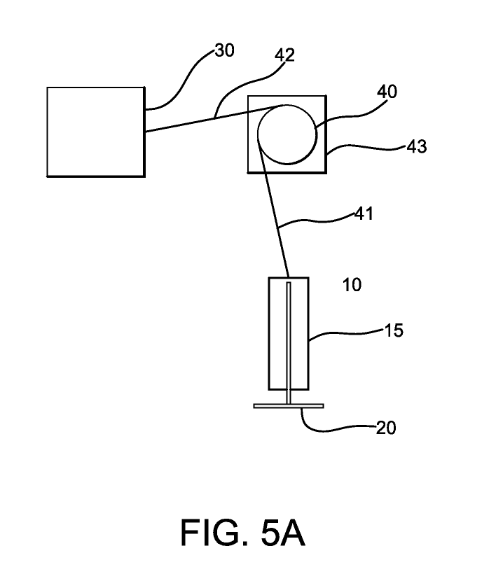

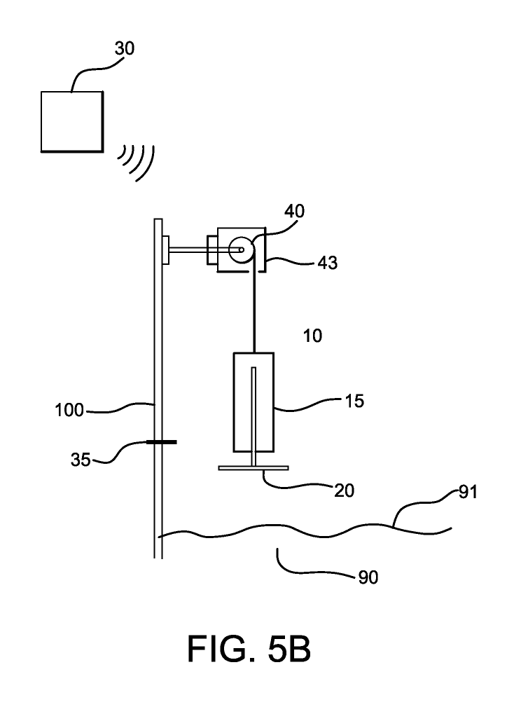

In a further preferred embodiment, as shown in FIG. 5A, the placement or depth location of the measuring device 10 within the vessel 100 may be varied through use of a coil device 40. The coil device 40 is positioned in between the processor 30 and the measuring device 10, to permit retraction or release of the segment of the connecting wire 41 extending between the coil device 40 and the measuring device 10. In another preferred embodiment, the coil device 40 may also coil the segment of connecting wire 42 between the processor 30 and coil device 40. For protection purposes, the coil device 40 may be within a housing 43.

In one preferred embodiment of the inventive system, one or both of the connecting wires 41 and 42 are shielded coaxial cables, such that the connecting wires 41, 42 are inactive extensions of the capacitance probe 15. For standard vessel applications, the accuracy of the measuring device is easily maintained for total wire lengths within the range of about 1 foot to in excess of about 30 feet. In other embodiments and for larger or deeper vessel applications, the total wire length is primarily determined by the size and capability of the coil device 40 and housing 43. Accordingly, for longer wire lengths, a larger and more powerful coil device 40 may be required.

As described above, the communication between the measuring device 10 and the computer processor 30 may, in a preferred embodiment, be wireless. In such an embodiment, the coiling device 40 could be located within the vessel near the top of a vessel wall as shown in FIG. 5B. If a trip level 35 were to change for varied conditions, for example where the vessel were derated due to age, the height of the measuring device 10 could be lowered through the coiling device 40.

As noted above, and as shown in FIG. 1C, the measuring device may be used within a vessel 100 that is open to the environment and weather, and has an external floating roof 70. The measuring device 10 in this application is exposed to all weather conditions including wind, rain, snow and freezing rain. In such conditions the detecting element 20 is also exposed to such environmental conditions, which could impair the proper operation of the detecting element 20. By way of example, if the detecting element 20 became covered with a layer of snow, ice, freezing rain, dirt, or dust, the measuring device 10 could sense a false trip or “contact” signal if the gap between the detecting element 20 and outer ground wall 17 is bridged with electrically conducting moisture, water, ice or snow. This could especially occur for the embodiment with the detecting element 20 being wider in diameter than the capacitance probe. Such false “contact” signals would prevent proper filling operations and should be prevented where possible.

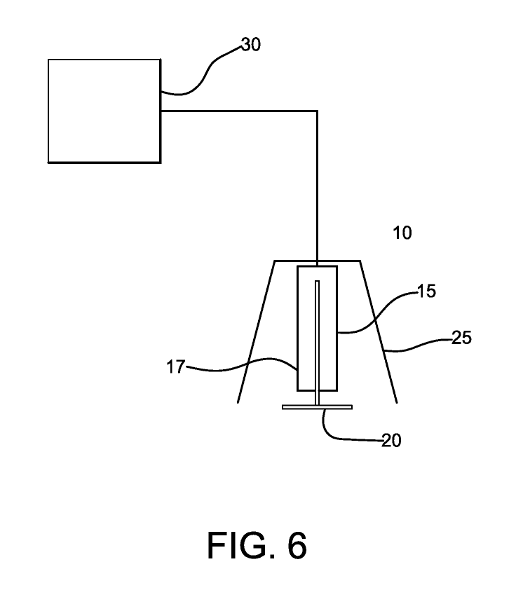

In a preferred embodiment to address this problem, and as illustrated in FIG. 6, a cover or shroud 25 may be located around and above the measuring device 10 to keep snow or freezing rain from collecting on the detecting element 20. In this design, snow and/or freezing rain is prevented from collecting on the detecting element 20 and bridging the gap between the detecting element 20 and the outer ground wall 17. In one preferred embodiment, the cover 25 may be designed, as illustrated in FIG. 6, such that the lower end of the cover 25 does not extend as far as the bottom of the detecting element 20. By having the detecting element 20 extend lower than the bottom of the cover 25, the measuring device 10 and detecting element 20 will properly operate even where the measuring device is not fully vertically oriented. One advantage of the FIG. 3D embodiment of the measure device 10 is that the problem of water, ice, freezing rain causing false trips is eliminated because the ground element 17 is surrounded by the active element 16 and not directly exposed to such environmental precipitation.

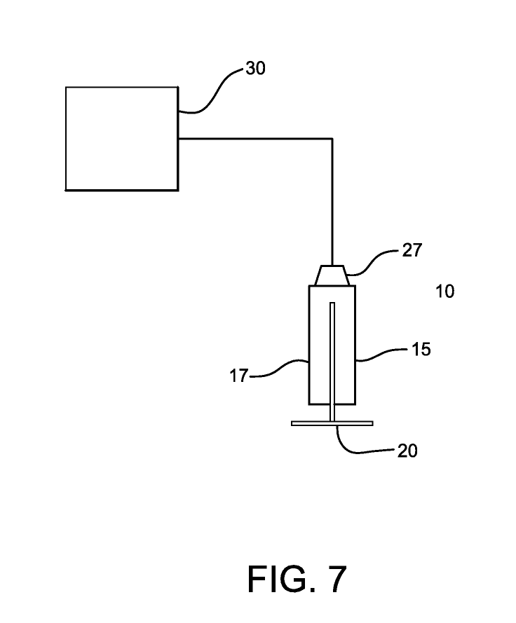

An alternative embodiment for use with process materials 90 that are not volatile, a heating element 27 could be incorporated with the measuring device 10. As shown in FIG. 7, the heating element 27 could be used to raise the temperature of the measuring device 10 if the weather or environmental conditions, such as freezing rain or snow, warrant the need to keep the measuring device 10 from becoming covered or layered in ice or snow.

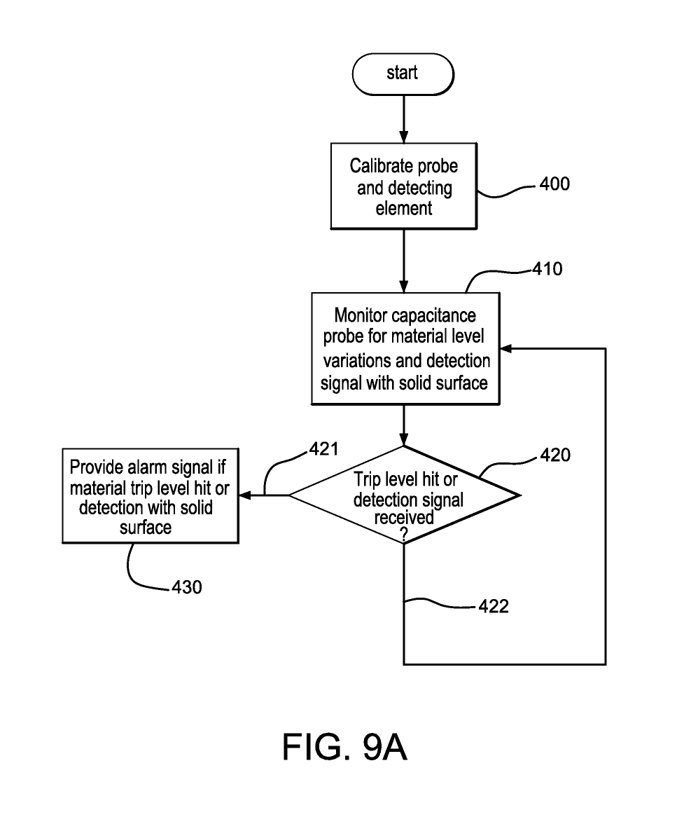

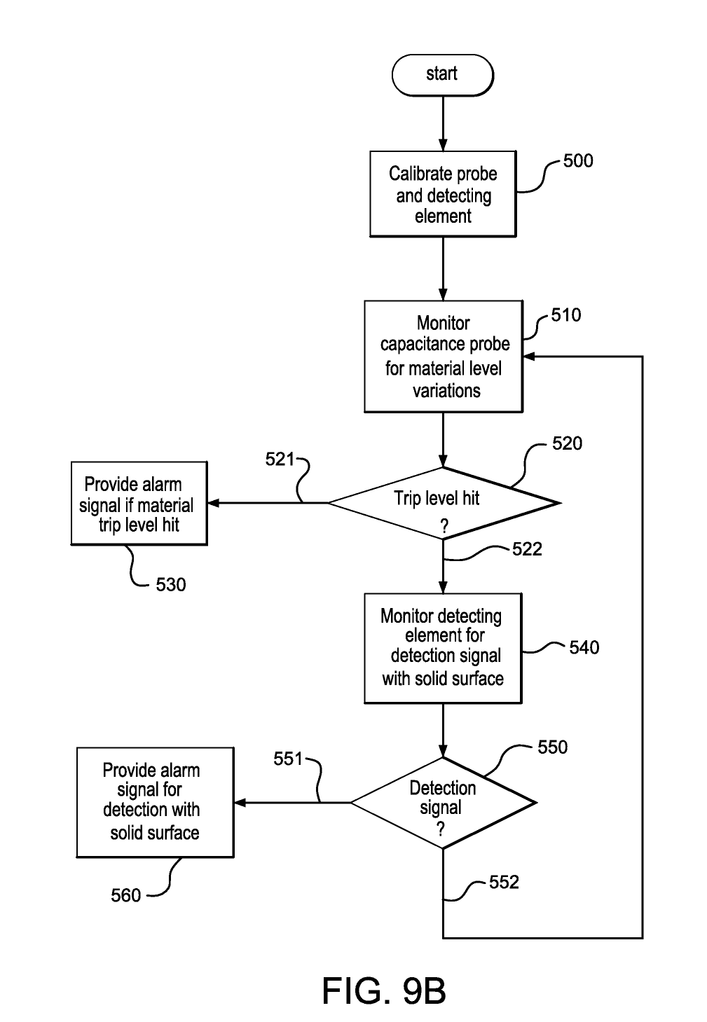

The method of operation using the inventive apparatus entails several key steps. Those steps include first calibrating the measuring device 10 through the system processor 30, then monitoring the level of the process material 90 within the vessel 100 and monitoring any detection signals between any solid surfaces 70, 75 within the vessel 100, capacitance probe, and while also providing output data or signals based upon the monitoring of the process material 90 level and any detection signals generated from the measuring device 10. FIG. 9A provides an example flowchart of a preferred embodiment of the inventive method for measuring the level of a process material while also monitoring detection of any solid surfaces within a vessel 100.

As shown by the steps in FIG. 9A, the system first calibrates 400 the probe to initialize the level of the process material 90 within the vessel 100. Thereafter, in a repetitive or feedback loop process the method undertakes a series of steps. The system monitors 410 the capacitance probe for variations in the measured capacitance data, which equate to variations in the level of the process material 90 and monitors whether a detection signal has been generated by the detecting element 20 or active element 16. In this embodiment, the system compares 420 whether the measured capacitance data/process material 90 level has “hit” the set trip level 35, or if a “contact” signal has been generated due to contact of a solid surface 70, 75 with the detecting element 20 or active element 16. If the measured capacitance data shows that the level of the process material 90 has reached 421 the trip level 35, or if a “contact” signal has been generated, then an alarm signal may be provided 430 to alert the system operator that the process material level has reached the trip level, or that a solid surface has contacted the probe and that no further material should be added to the vessel 100, or that some of the process material should be removed from the vessel 100.

If the measured capacitance data indicates that the process material 90 has not reached 422 the set trip level 35, or no “contact” signal has been generated, then the system repeats the monitoring step 510.

An alternative embodiment of the inventive method of operation provides for separate monitoring of the process material level as distinct from monitoring any contact detections with solid surfaces 70, 75. More specifically, as shown in FIG. 9B, the alternative embodiment system first calibrates 500 the probe and detecting element to initialize the level of the process material 90 within the vessel 100, and sets or resets the detecting element 20 or active element 16. Thereafter, in a repetitive or feedback loop process the method undertakes a series of steps. First, the system monitors 510 the capacitance probe for variations in the measured capacitance data, which equate to variations in the level of the process material 90. The system processor may provide output data, and system readouts showing the system operator the level of the process material 90 within the vessel 100.

The system next may compare 520 the measured capacitance data/process material 90 level with a set trip level 35. If the measured capacitance data shows that the level of the process material 90 has reached 521 the trip level 35, then an alarm signal may be provided 530 to alert the system operator that the process material level has reached the trip level, and that no further material should be added to the vessel 100, or that some of the process material should be removed from the vessel 100.

If the measured capacitance data indicates that the process material 90 has not reached 522 the set trip level 35, the system also monitors 540 the detecting element 20 for any signals showing contact between any solid surfaces 70, 75 within the vessel 100 and the detecting element 20. The system inquiries 550 whether a detection signal has been generated by the detecting element 20. If a detection signal has been generated 551, then an alarm signal may be provided 560 to the system operator advising that a solid surface contact with the detecting element 20 has been observed. If no detection signal has been generated 552, then the system repeats the monitoring steps 510 and 540.

While FIG. 9B shows an example ordering of the monitoring steps, it should be understood that the monitoring steps 510 and 540, along with the related inquiry steps 520 and 550, may be reordered such that the monitoring of the detecting element 20 (or active element 16) may be completed before, or in parallel to the monitoring of the capacitance probe.

The above detailed description teaches certain preferred embodiments of the present inventive measuring and detecting apparatus, and method of measuring and detecting using the disclosed apparatus. As described, the inventive measuring device and system provide high precision measurement of the surface level of a material stored in a vessel, and the ability to reliably detect contacts with a solid surface with the vessel, such as a floating roof. While preferred embodiments of the measuring and detecting apparatus and system, and the method of measuring and detecting have been described and disclosed, it will be recognized by those skilled in the art that various modifications and/or substitutions are possible. All such modifications and substitutions are intended to be within the true scope and spirit of the present invention as disclosed. It is likewise understood that the attached claims are intended to cover all such modifications and/or substitutions.

What is claimed is:

1. An apparatus for measuring the level of a material within a vessel and for detecting the level of a solid surface within said vessel, comprising:
a capacitance probe for measuring the level of the material within the vessel to a high degree of precision, said capacitance probe having an active element and a ground element in close lateral proximity to each other, said capacitance probe further having a proximate end and a distal end; and
a detection element incorporated into the distal end of the capacitance probe for detecting the level of a solid surface within the vessel.

2. The apparatus for measuring the level of a material within a vessel, as provided in claim 1, wherein the capacitance probe has a fixed height within the vessel.

3. The apparatus for measuring the level of a material within a vessel, as provided in claim 1, wherein the capacitance probe may be positioned at varied heights within the vessel.

4. The apparatus for measuring the level of a material within a vessel, as provided in claim 1, further comprising a cable coiling device to permit the capacitance probe to be placed at varied depths within the vessel.

5. A system for measuring the surface level of a material stored within a vessel, comprising:
a capacitance probe for measuring the level a material within the vessel, said capacitance probe having a proximate end and a distal end;
a detection element coupled with the distal end of the capacitance probe for detecting the level of a solid surface within the vessel; and
a computer processor to calibrate and monitor the capacitance probe.

6. The system for measuring the level of a material within a vessel, as provided in claim 5, wherein the capacitance probe and detection element communicate with the computer processor wirelessly.

7. The apparatus for measuring the level of a material within a vessel, as provided in claim 1, further comprising a cover to protect the capacitance probe from weather elements.

8. The apparatus for measuring the level of a material within a vessel, as provided in claim 1, further comprising a cover to protect the detection element from weather elements.

9. The apparatus for measuring the level of a material within a vessel, as provided in claim 1, further comprising a heating element to heat the capacitance probe.

10. The apparatus for measuring the level of a material within a vessel, as provided in claim 1, further comprising a heating element to heat the detection element.

11. An apparatus for measuring the level of a material within a vessel and for detecting the level of a solid surface within said vessel, comprising:
a capacitance probe for measuring the level of the material within the vessel, said capacitance probe having an active element and a ground element, wherein the active element and ground element are in a co-axial relationship with each other; and
said active element detects the level of a solid surface within the vessel.

12. The apparatus for measuring the level of a material within a vessel, as provided in claim 11, wherein the capacitance probe has a fixed height within the vessel.

13. The apparatus for measuring the level of a material within a vessel, as provided in claim 11, wherein the capacitance probe may be positioned at varied heights within the vessel.

14. The apparatus for measuring the level of a material within a vessel, as provided in claim 11, further comprising a cable coiling device to permit the capacitance probe to be placed at varied depths within the vessel.

15. A system for measuring the surface level of a material stored within a vessel, comprising:
a capacitance probe for measuring the level of the material within the vessel, said capacitance probe having an active element and a ground element, wherein the active element and ground element are in a co-axial relationship with each other; and
said active element detects the level of a solid surface within the vessel; and
a computer processor to calibrate and monitor the capacitance probe.

16. The system for measuring the level of a material within a vessel, as provided in claim 15, wherein the capacitance probe communicates with the computer processor wirelessly.

17. The apparatus for measuring the level of a material within a vessel, as provided in claim 11, further comprising a heating element to heat the capacitance probe.

18. A method for measuring the level of a material or distinct solid surface within a vessel using a capacitance probe coupled with a detection element, and a computer processor, comprising the steps of:
(a) calibrating the level of the capacitance probe through the computer processor;
(b) monitoring the level of the material within the vessel, and monitoring any contacts of solid surfaces with the detection element, through the computer processor; and
(c) providing output data of the material level as measured by the capacitance probe or if a solid surface contacts the detection element.

19. The method for measuring the level of a material or distinct solid surface within a vessel using a capacitance probe coupled with a detection element, and a computer processor, as provided in claim 18, wherein the capacitance probe has a fixed height within the vessel.

20. The method for measuring the level of a material or distinct solid surface within a vessel using a capacitance probe coupled with a detection element, and a computer processor, as provided in claim 18, wherein the capacitance probe may be positioned at varied heights within the vessel.

21. The method for measuring the level of a material or distinct solid surface within a vessel using a capacitance probe coupled with a detection element, and a computer processor, as provided in claim 18, further comprising a cable coiling device to permit the capacitance probe to be placed at varied depths within the vessel.

22. The method for measuring the level of a material or distinct solid surface within a vessel using a capacitance probe coupled with a detection element, and a computer processor, as provided in claim 18, wherein the capacitance probe and detection element communicate wirelessly with the computer processor.

23. A method for measuring the level of a material or distinct solid surface within a vessel using a capacitance probe coupled with a detection element, and a computer processor, comprising the steps of:
(a) calibrating the level of the capacitance probe through the computer processor;
(b) monitoring the level of the material within the vessel through the computer processor;
(c) providing output data of the material level as measured by the capacitance probe;
(d) monitoring any contacts of solid surfaces with the detection element through the computer processor; and
(e) providing output data if a solid surface contacts the detection element.
